(19) United States
(12) Patent Application Publication
(10) Pub. No.: US 2025/0298560 A1
(43) Pub. Date: Sep. 25, 2025

(54) IMAGE PROCESSING APPARATUS AND METHOD

(71) Applicant: CANON KABUSHIKI KAISHA, Tokyo (JP)

(72) Inventors: YUYA TANAKA, Kanagawa (JP); HIROYUKI YAMAMOTO, Woodbury, NY (US)

(21) Appl. No.: 19/081,409

(22) Filed: Mar. 17, 2025

(30) Foreign Application Priority Data
Mar. 19, 2024 (JP) 2024-044106

(51) Int. Cl. G06F 3/12

(52) U.S. Cl. CPC G06F 3/1232; G06F 3/1203; G06F 3/1287

(57) ABSTRACT

An image processing apparatus includes one or more memories storing instructions and one or more processors capable of executing the instructions. Execution of the instructions causes the one or more processors to control the image processing apparatus to transmit a request including identification information of the image processing apparatus to a management server in order to use a first service, in a case where an input is received with respect to an arrangement on transmission of first information about use of the image processing apparatus excluding personal information of a user of the image processing apparatus, and provide a screen for acquiring an arrangement on transmission of second information about use of the image processing apparatus including the personal information based on a notification from the management server in order to use the first service.

### BACKGROUND

### Field of the Disclosure

The present disclosure relates to a technique for transmitting use information of an image processing apparatus to an external system via a network.

### Description of the Related Art

A service has widely been provided which is used to transmit use information of an image processing apparatus to a vendor by connecting the image processing apparatus to the internet. In recent years, an image processing apparatus has been provided which can be used for both a corporate service and a personal cloud service. The corporate service allows a company to manage printing information of a home-based worker, and the personal cloud service cooperates with various cloud services to allow a user to print photographs or documents from a social networking service (SNS) or a photo-sharing site. In order to use the above-described services, the user has to agree to provide the use information of the image processing apparatus to a vendor via the internet.

Japanese Patent Application Laid-Open No. 2022-191846 discusses an information processing apparatus that allows a user to save time to go through agreement procedures for disclosing personal information every time the user applies for a service.

However, techniques discussed in Japanese Patent Application Laid-Open No. 2022-191846 cannot flexibly control transmission of device information with consideration for the user's agreement status based on the purpose of use of the image processing apparatus.

### SUMMARY

According to an aspect of the present disclosure, an image processing apparatus includes one or more memories storing instructions and one or more processors capable of executing the instructions. Execution of the instructions causes the one or more processors to control the image processing apparatus to transmit a request including identification information of the image processing apparatus to a management server in order to use a first service, in a case where an input is received with respect to an arrangement on transmission of first information about use of the image processing apparatus excluding personal information of a user of the image processing apparatus, and provide a screen for acquiring an arrangement on transmission of second information about use of the image processing apparatus including the personal information based on a notification from the management server in order to use the first service.

Further features of various embodiments will become apparent from the following description of exemplary embodiments with reference to the attached drawings.

### BRIEF DESCRIPTION OF THE DRAWINGS

FIG. 1 is a diagram illustrating a system configuration.

FIG. 2 is a block diagram illustrating a hardware configuration of a server apparatus.

FIG. 3 is a block diagram illustrating a hardware configuration of a printer.

FIG. 4 is a sequence diagram illustrating processing for storing data indicating a personal Web service agreement.

FIG. 5 is a flowchart illustrating processing for displaying the personal Web service agreement screen.

FIGS. 6A and 6B are tables stored in a database of a printer management server.

FIGS. 7A to 7C are diagrams illustrating examples of Web service agreement screens.

FIG. 8 is a sequence diagram illustrating processing to be executed when a personal Web service is registered additionally.

FIG. 9 is a table stored in the database within the printer management server.

FIG. 10 is a diagram illustrating an example of a Web service warning screen.

### DESCRIPTION OF THE EMBODIMENTS

Hereinafter, exemplary embodiments of the present disclosure will be described in detail with reference to the appended drawings. The embodiments described hereinafter are not intended to limit every embodiment of the present disclosure according to the scope of the appended claims, and not all of the combinations of features described in the exemplary embodiments are essentially required for solutions of the present disclosure.

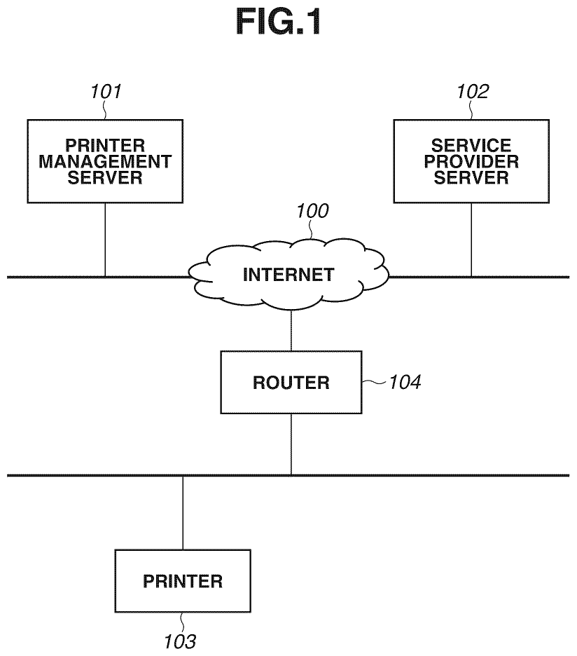

FIG. 1 is a diagram illustrating an example of a system configuration according to a first exemplary embodiment.

As illustrated in FIG. 1, an information processing system according to the present exemplary embodiment includes a printer management server 101, a service provider server 102, and a printer 103 serving as a recording apparatus.

The printer management server 101 and the service provider server 102 are each connected to the internet 100. The printer 103 can be connected to the internet 100 via a router 104. The printer management server 101 is a management server capable of managing information transmitted from the printer 103 and providing the information to the service provider server 102 via the internet 100. Communications between the above-described units are controlled through a hypertext transfer protocol (HTTP) or an extensible messaging and presence protocol (XMPP). Protocols are not limited to the above, and another protocol can also be used. The printer 103 periodically transmits status information including information about the number of printed sheets and an ink remaining amount to the printer management server 101 together with identification information (e.g., serial number) of the printer 103. The printer management server 101 transmits the information received from the printer 103 to the service provider server 102 depending on the service in which the printer 103 is registered.

In the present exemplary embodiment, the service provider server 102 can provide various services for supporting a plurality of purposes of use of the image processing apparatus. Examples of corporate Web services include a service that allows a company who makes a contract to manage information about printing operations executed by a home-based worker. Examples of the personal Web service include a printing service which cooperates with various cloud services to allow a user to print photographs or documents from a social networking service (SNS) or a photo-sharing site, and a service which provides points based on the number of times of printing executed by the user.

A printing subscription service is also available as an example of the personal Web service. The present exemplary embodiment discusses that the service provider server 102 provides a plurality of services. However, a service provider server can also be provided for every one or more services.

### Server Configuration

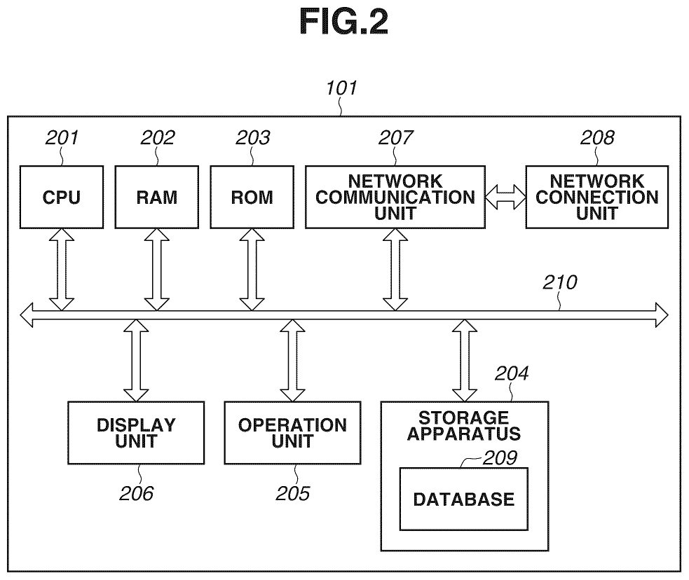

FIG. 2 is a block diagram illustrating an example of a hardware configuration of the printer management server 101. Hereinafter, a configuration of the printer management server 101 according to the present exemplary embodiment will be described with reference to FIG. 2.

The printer management server 101 includes a central processing unit (CPU) 201, a random access memory (RAM) 202, a read only memory (ROM) 203, a storage apparatus 204, an operation unit 205, a display unit 206, a network communication unit 207, and a network connection unit 208.

The CPU 201 is a central processing unit for controlling respective units included in the printer management server 101. The RAM 202 serves as a work memory to be used when the CPU 201 executes a program. The ROM 203 is a read only memory for storing a boot program to be used for activating the system. The storage apparatus 204 is an apparatus which stores a program executed by the CPU 201, a database 209, and various types of information. For example, the storage apparatus 204 is a non-volatile storage apparatus such as a magnetic disk or a flash memory. The operation unit 205 includes a keyboard and a mouse through which the user performs various input operations. The display unit 206 includes, for example, a liquid crystal display (LCD), and displays and provides various types of information to the user. The network communication unit 207 is connected to a network such as the internet 100 via the network connection unit 208, and executes various communications. The above-described units are mutually connected to each other via a bus 210, and can mutually transmit and receive data.

The service provider server 102 has a hardware configuration similar to that of the printer management server 101. Thus, descriptions thereof will be omitted. However, the service provider server 102 may have a hardware configuration different from that of the printer management server 101.

FIG. 2 illustrates the printer management server 101 having one server (i.e., information processing apparatus). However, the printer management server 101 may include a plurality of servers. In other words, a plurality of servers may cooperatively operate to execute the respective functions. Similarly, the service provider server 102 may consist of a plurality of servers. In the present disclosure, a system consisting of one or more servers is referred to as a server system.

### Hardware Configuration of Printer

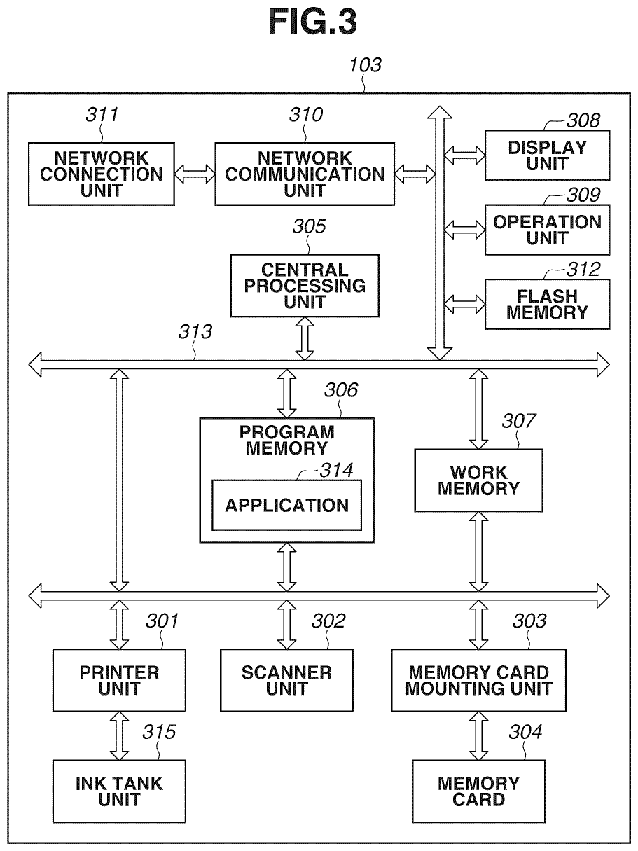

FIG. 3 is a block diagram illustrating an example of a hardware configuration of the printer 103.

Hereinafter, a configuration of the printer 103 according to the present exemplary embodiment will be described with reference to FIG. 3. The printer 103 includes a printer unit 301, a scanner unit 302, a memory card mounting unit 303, a memory card 304, and an ink tank unit 315. The printer 103 further includes a CPU 305, a program memory 306, a work memory 307, a display unit 308, an operation unit 309, a network communication unit 310, a network connection unit 311, and a flash memory 312. In the present exemplary embodiment, the printer 103 operating as a multifunction peripheral will be described as an example of a recording apparatus. However, a recording apparatus to which the present exemplary embodiment is applicable does not have to be a multifunction peripheral.

An image processing apparatus such as a copying machine or a facsimile, or a printer having no scanner function can also be used. Further, a printer which executes recording by using ink will be described as an example of the recording apparatus according to the present exemplary embodiment, but the present exemplary embodiment can also be applied to an apparatus using toner as a recording material.

The printer 103 realizes a printing function with the printer unit 301. The scanner unit 302 realizes a scanner function, and the memory card mounting unit 303 and the memory card 304 realize a storage function. The printer unit 301 records (i.e., prints) an image on a recording medium such as a printing sheet using an ink jet method based on image data received from the outside or stored in the memory card 304. The printer unit 301 also manages information about a remaining ink amount and sheet information including information about the number of stacked sheets.

The scanner unit 302 optically reads and converts an image of a document placed on a document positioning plate (not illustrated) into electronic data. The scanner unit 302 transmits image data converted into a specified file format to an external apparatus via the network, and stores the image data in a storage area such as a hard disk drive (not illustrated). Further, image data generated by the scanner unit 302 by reading a document placed on the document positioning plate is transmitted to the printer unit 301, so that a copy function is implemented by the printer unit 301 by recording an image on a recording medium based on the image data. Various types of file data is stored in the memory card 304 mounted on the memory card mounting unit 303. This file data can be read and edited by an external apparatus via the network. The file data can also be stored in the memory card 304 according to an instruction from the external apparatus.

The CPU 305 is a central processing unit for controlling respective units within the printer 103. The program memory 306 includes a ROM, and stores various program codes and an application 314 for communicating with the printer management server 101. The work memory 307 includes a RAM. The work memory 307 temporarily stores image data when a service is executed, and executes buffering with the work memory 307. The display unit 308 is configured by, for example, an LCD, and displays various types of information. The operation unit 309 consists of switches through which the user performs various input operations. The network communication unit 310 is connected to the router 104 via the network connection unit 311. In other words, the network communication unit 310 is connected to a network such as the internet 100 via the network connection unit 311 to execute various communications. Various communications are controlled through the HTTP or the XMPP. The protocols are not limited to the above, and another protocol can also be used. The flash memory 312 is a non-volatile memory for storing image data received by the network communication unit 310. The above-described units are mutually connected to each other via a bus 313, and can mutually transmit and receive data. The ink tank unit 315 is mounted with an ink cartridge including an ink tank for containing ink used by the printer unit 301. In a case where toner is used as a recording material, a toner cartridge can also be mounted.

### Printer Web Service Setting Screen

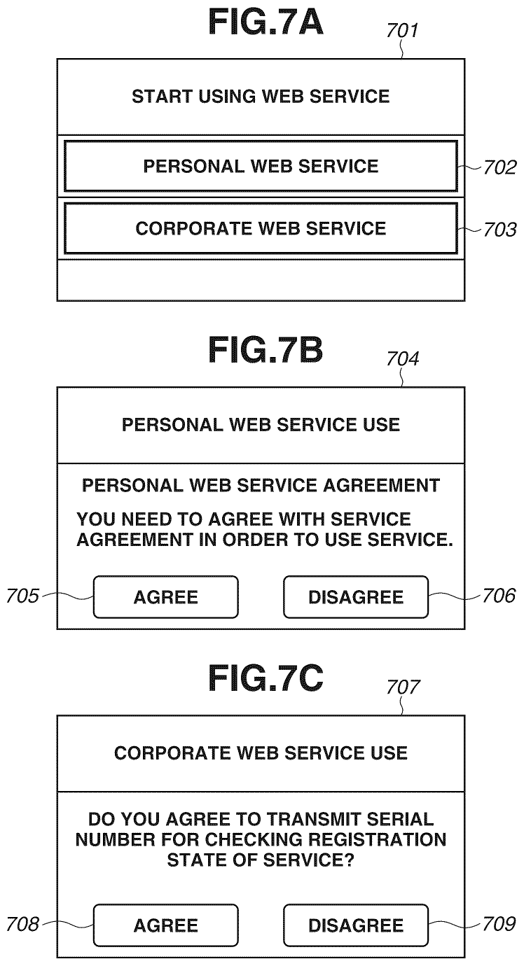

FIGS. 7A to 7C illustrate examples of a Web service start screen 701, a personal Web service agreement screen 704, and a corporate Web service agreement screen 707 displayed on the display unit 308 of the printer 103.

The Web service start screen 701 in FIG. 7A includes a personal Web service button 702 for selecting use of a personal Web service and a corporate Web service button 703 for selecting use of a corporate Web service.

For example, the corporate Web service button 703 is selected when the user uses a printer which a company the user belongs has provided for the business use, or when the user uses a printer which the user owns for the personal use as well as the business use.

When the user presses the personal Web service button 702, the printer 103 changes the Web service start screen 701 to the personal Web service agreement screen 704. When the user presses the corporate Web service button 703, the printer 103 changes the Web service start screen 701 to the corporate Web service agreement screen 707.

The personal Web service agreement screen 704 in FIG. 7B includes an agree button 705 for selecting “Agree” and a disagree button 706 for selecting “Disagree”. When the user presses the agree button 705, the printer 103 enables a printer information transmission setting. The printer information transmission setting is enabled when the printer 103 transmits information to be used for the personal Web service to an external service server via the network.

Pieces of information are included in the information to be transmitted, such as status information of the printer 103 (e.g., information indicating an operation status such as an error, information indicating a remaining ink amount, and information about a recording material such as the number of printed sheets), printing information to be used for executing printing, and personal information for identifying an individual user. The printer information transmission setting also includes a setting related to a transmission timing. Thus, based on the setting, the information is automatically transmitted at a periodic timing or at a timing when a predetermined condition is satisfied.

The corporate Web service agreement screen 707 in FIG. 7C includes an agree button 708 for selecting “Agree” and a disagree button 709 for selecting “Disagree”. When the user presses the agree button 708, the printer 103 automatically transmits identification information of the printer 103 (e.g., serial number) to the printer management server 101 at a periodic timing or at a timing when a predetermined condition is satisfied. As a result of this transmission, the printer 103 can acquire registration information of the corporate Web service from a transmission destination.

In a case where the agree button 708 is selected, a corporate service information transmission setting is enabled. The corporate service information transmission setting is enabled when the information is transmitted to an external corporate service server via the network.

Pieces of information are included in the information to be transmitted excluding the personal information for identifying an individual user, such as the status information of the printer 103 to be used for the corporate Web service (e.g., information indicating an operation status such as an error, information indicating a remaining ink amount, and information about a printing material such as the number of printed sheets), and printing information to be used for executing printing. The corporate service information transmission setting also includes a setting related to a transmission timing. Thus, based on the setting, the information is automatically transmitted at a periodic timing or at a timing when a predetermined condition is satisfied.

### Processing for Registering a Web Service Including a Personal Service and Starting Transmission of Printer Information

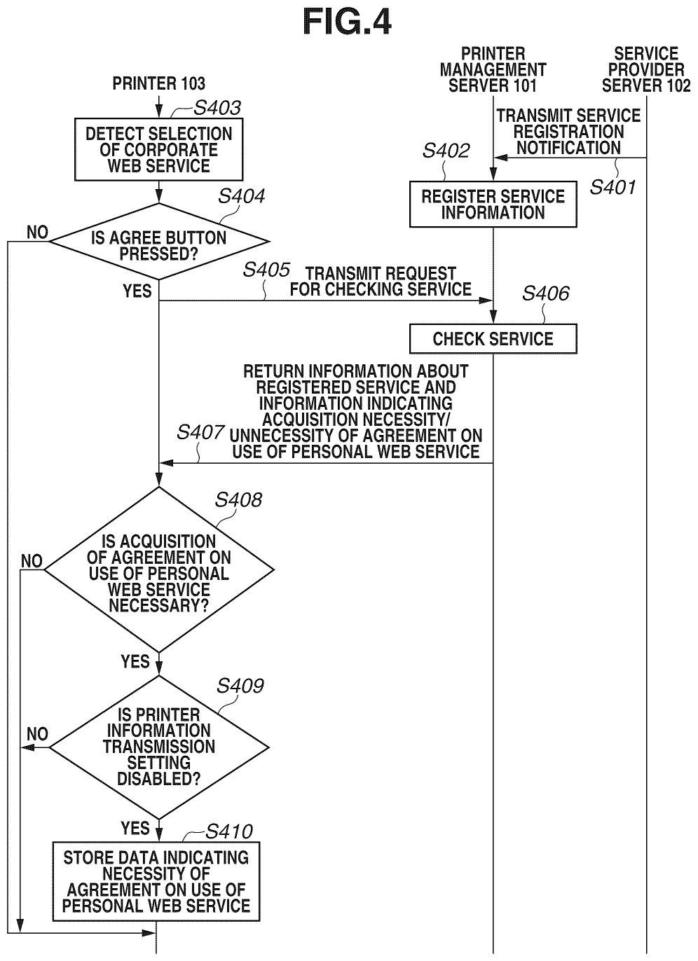

FIG. 4 is a sequence diagram illustrating an example of a series of processing for from registering a Web service including a personal service to starting transmission of printer information.

The series of processing is executed by respective CPUs included in the printer management server 101, the service provider server 102, and the printer 103. In other words, the series of processing is executed by each of the CPUs by loading a program code stored in the storage apparatus into the RAM and executing the program code. Alternatively, all or a part of the functions implemented by respective steps illustrated in FIG. 4 can be implemented by an electronic circuit such as an application specific integrated circuit (ASIC) or hardware.

In step S401, when the service provider server 102 receives an input for registering a service from the user, the service provider server 102 transmits a service registration notification to the printer management server 101. The service registration notification includes a name of the registered Web service, identification information of the printer 103 such as a serial number, and information about an installation site. Although a serial number is given as an example of the identification information for identifying the printer 103, other information such as a media access control (MAC) address can also be used for the identification information.

In step S402, the printer management server 101 registers the identification information of the printer 103, the name of the registered Web service, and the information about an installation site received in step S401, in association with each other, in a printer management table 602 stored in the database 209 within the printer management server 101.

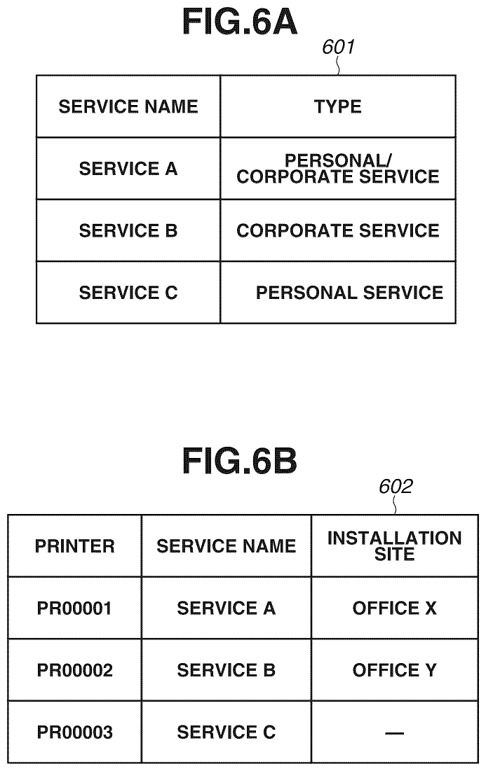

FIGS. 6A and 6B are diagrams illustrating examples of a service table 601 and the printer management table 602 stored in the database 209 within the printer management server 101.

The printer management server 101 previously registers and manages information about a name and a type of each of the Web services in association with each other, in the service table 601 in FIG. 6A. The information about the name and the type indicates whether each Web service indicates a personal service, a corporate service, or both of the personal and corporate services.

When the printer management server 101 receives the service registration notification from the service provider server 102, the printer management server 101 registers, in association with each other, identification information of the printer 103, a name of the Web service, and information about an installation site, in the printer management table 602 in FIG. 6B.

Referring back to the sequence diagram in FIG. 4, in step S403, the printer 103 displays the Web service start screen 701 on the display unit 308, and detects a press of the corporate Web service button 703.

In step S404, the printer 103 displays the corporate Web service agreement screen 707 on the display unit 308, and determines whether the agree button 708 is pressed. In a case where the printer 103 determines that the agree button 708 is selected, the determination result in step S404 becomes “True”, and thus the corporate service information transmission setting is enabled as described above. In a case where the determination result is “True” (YES in step S404), the processing proceeds to step S405. In contrast, in a case where the determination result is “False” (NO in step S404), the processing ends.

In step S405, the printer 103 transmits a request for checking the service to the printer management server 101 together with the identification information of the printer 103.

In step S406, based on the identification information of the printer 103 received in step S405, the printer management server 101 refers to the printer management table 602 stored in the database 209 within the printer management server 101 to check the name of the registered service. The printer management server 101 also refers to the service table 601 stored in the database 209 within the printer management server 101 to check whether the registered Web service includes a personal service.

In step S407, the printer management server 101 notifies the printer 103 of the service information. With this notification, the printer management server 101 returns, to the printer 103, the service information which includes information about a name and a type of the service the printer 103 is registered and information indicating acquisition necessity/unnecessity of an agreement on use of the personal Web service. The information indicating acquisition necessity/unnecessity of an agreement on use of the personal Web service indicates “Necessary” in a case where the service checked in step S406 is a service of a type which includes a personal service, and indicates “Unnecessary” in other cases.

In step S408, the printer 103 determines whether acquisition of an agreement on use of the personal Web service is “Necessary”. In a case where the determination result is “True” (YES in step S408), the processing proceeds to step S409. In contrast, in a case where the determination result is “False” (NO in step S408), the processing ends.

In step S409, the printer 103 determines whether the printer information transmission setting is disabled. In a case where the determination result is “True” (YES in step S409), the processing proceeds to step S410. In contrast, in a case where the determination result in step S409 is “False” (NO in step S409), the processing is ended.

In step S410, the printer 103 stores data indicating necessity of an agreement on use of the personal Web service in the flash memory 312 included in the printer 103. Thereafter, the processing ends.

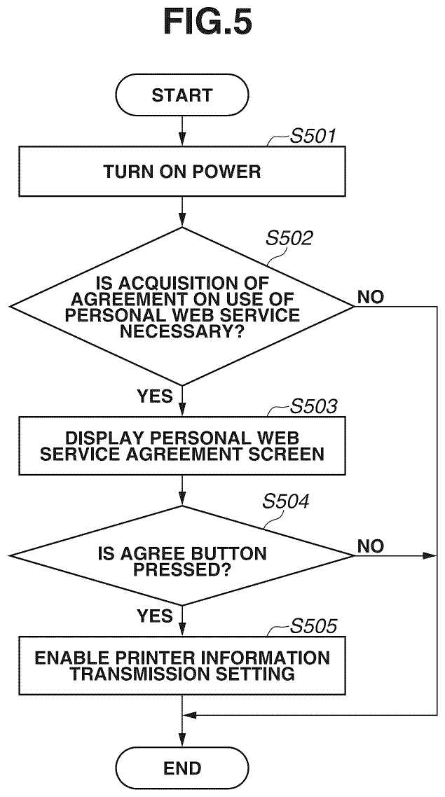

FIG. 5 is a flowchart illustrating a series of processing which the printer 103 executes to enable the printer information transmission setting. The series of processing illustrated in the flowchart in FIG. 5 is implemented by the CPU 305 of the printer 103 loading a program code stored in a disk device or the like on the RAM and executing the program code. In addition, it is assumed that the printer 103 is in a power-off state before the series of processing illustrated in the flowchart in FIG. 5 is started.

The processing is started when a press of the power button of the printer 103 is detected. In step S501, the CPU 305 brings the printer 103 into a power-on state from a power-off state.

In step S502, the CPU 305 determines whether the printer 103 needs to acquire an agreement on use of the personal Web service. In step S502, the determination result becomes “True” in a case where data indicating necessity of an agreement on use of the personal Web service is stored in the flash memory 312 in step S410 described above. In a case where the determination result is “True” (YES in step S502), the processing proceeds to step S503. In contrast, in a case where the determination result is “False” (NO in step S502), the processing ends.

In step S503, the CPU 305 provides the personal Web service agreement screen 704 on the display unit 308 of the printer 103. Although the screen 704 is provided and displayed on the display unit 308 of the printer 103 in step S503, the screen 704 can be provided to a mobile terminal owned by the user of the printer 103. In step S504, the CPU 305 determines whether the agree button 705 displayed on the personal Web service agreement screen 704 is pressed. In a case where the determination result is “True” (YES in step S504), the processing proceeds to step S505. In contrast, in a case where the determination result is “False” (NO in step S504), the processing ends.

In step S505, the CPU 305 enables the printer information transmission setting. While the printer information transmission setting is being enabled, the printer 103 transmits the use information of the printer 103 to the service provider which provides the contracted service via the network at a timing when a predetermined condition is satisfied or at a periodic timing. The predetermined condition to be satisfied may be a condition that a power is turned on, a condition that printing or copying is executed, or a condition that the user performs a predetermined operation on a screen displayed by the printer 103.

According to the present exemplary embodiment, in a case where a service previously registered at the service provider (i.e., a service the user has previously made a contract with the service provider) includes both of a personal service and a corporate service, the printer 103 can stop transmitting the use information of the printer 103 until the user agrees to use the personal service even if the user has already agreed to use the corporate service.

### Application Example

In the above-described exemplary embodiment, the printer 103 stores the data indicating necessity of an agreement on use of the personal Web service, and displays the personal Web service agreement screen 704 at a timing when the power of the printer 103 is turned on next time. However, the present exemplary embodiment is not limited to the above-described embodiment.

Specifically, the personal Web service agreement screen 704 can be displayed at a timing when the printer 103 receives the information indicating “Necessity” of an agreement on use of the personal Web service from the printer management server 101 (i.e., in a case where a determination result in step S409 is “True”).

Further, in the above-described exemplary embodiment, the identification information of the printer 103 is transmitted in step S405. However, information indicating a disabled state of the printer information transmission setting of the printer 103 can also be transmitted.

In the above-described exemplary embodiment, the printer management server 101 determines the acquisition necessity/unnecessity of an agreement on use of the personal Web service on the basis of whether the registered service is a service of a type which includes a personal service. However, this determination can be executed based on the information about the installation site of the printer 103.

A second exemplary embodiment is described with respect to a case where registration of the personal Web service is newly executed in a state where the printer 103 has already been registered for the corporate Web service. In the present exemplary embodiment, the contents different from the contents of the first exemplary embodiment will mainly be described while descriptions of the contents common to the contents of the first exemplary embodiment will be omitted as appropriate.

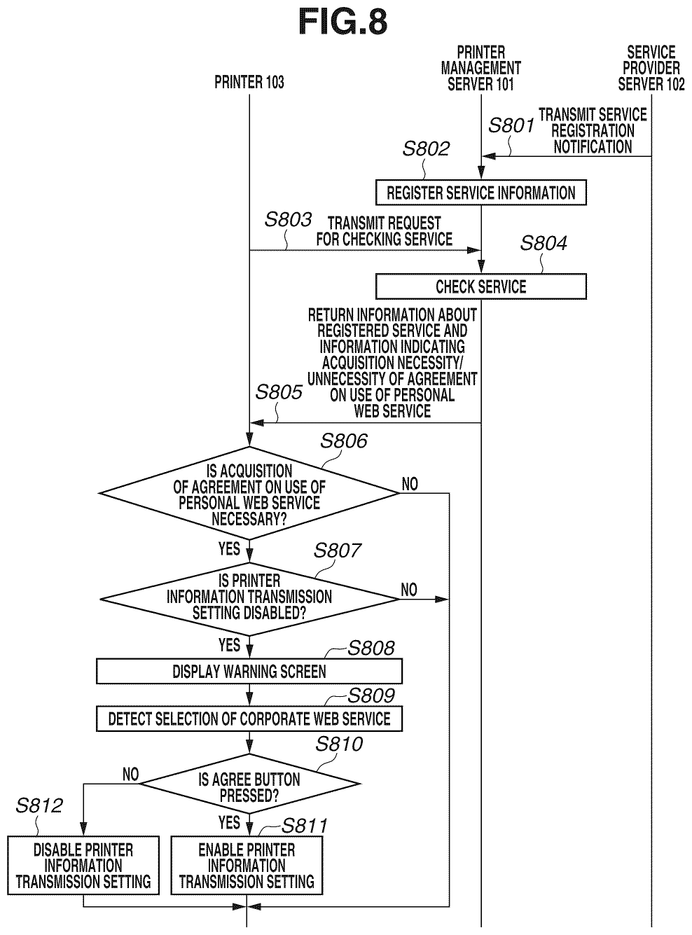

Similarly to FIG. 4 described in the first exemplary embodiment, FIG. 8 illustrates a series of processing executed when the personal Web service is newly registered for the printer 103 used for the corporate Web service. Similar to FIG. 4, the series of processing is executed by the CPUs included in the printer management server 101, the service provider server 102, and the printer 103.

The contents of steps S801 and S802 are similar to the contents of steps S401 and S402 in FIG. 4.

In step S803, the printer 103 transmits a request for checking the service to the printer management server 101 together with the identification information of the printer 103. In the present exemplary embodiment, checking of the service is executed at a periodic timing or at a timing when a predetermined condition, such as a condition that a power is turned on, is satisfied.

In step S804, based on the identification information of the printer 103 received in step S803, the printer management server 101 refers to the printer management table 901 stored in the database 209 within the printer management server 101 to check all of the names of registered services. The printer management server 101 further refers to the service table 601 stored in the database 209 within the printer management server 101 to check whether each of the registered services is a Web service of a type which includes a personal service.

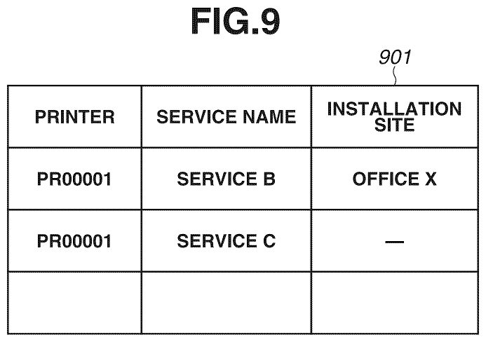

FIG. 9 illustrates an example of a printer management table 901 stored in the database 209 within the printer management server 101. The printer management table 901 indicates that the printer 103 is registered for a plurality of Web services.

In step S805, the printer management server 101 notifies the printer 103 of service information which includes information about a name and a type of the service for which the printer 103 is registered and information indicating acquisition necessity/unnecessity of an agreement on use of the personal Web service. In step S805, in a case where the printer 103 is registered for a plurality of services, the printer management server 101 returns the service information with respect to all of the registered services.

In step S806, the printer 103 determines whether at least one piece of service information indicating acquisition necessity of an agreement on use of a personal Web service is included in the pieces of received service information. In a case where the determination result is “True” (YES in step S806), the processing proceeds to step S807. In contrast, in a case where the determination result is “False” (NO in step S806), the processing ends.

In step S807, the printer 103 determines whether the printer information transmission setting is disabled. In a case where the determination result is “True” (YES in step S807), the processing proceeds to step S808. In contrast, in a case where the determination result is “False” (NO in step S807), the processing ends.

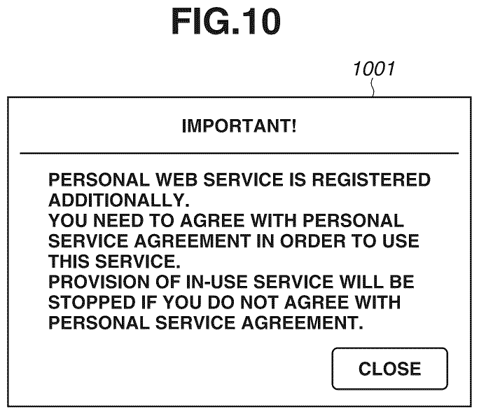

FIG. 10 illustrates an example of the Web service warning screen 1001 displayed on the display unit 308 of the printer 103. In step S808, the printer 103 displays the Web service warning screen 1001 on the display unit 308. The Web service warning screen 1001 displays a message describing that the user needs to agree to use a personal service because the service is additionally contracted/registered.

In step S809, the printer 103 displays the personal Web service agreement screen 704 on the display unit 308 of the printer 103 when the printer 103 detects closing of the Web service warning screen 1001 displayed in step S808.

In step S810, the printer 103 determines whether the agree button 705 displayed on the personal Web service agreement screen 704 is pressed. In a case where the determination result is “True” (YES in step S810), the processing proceeds to step S811. In contrast, in a case where the determination result is “False” (NO in step S810), the processing proceeds to step S812.

In step S811, the printer 103 enables the printer information transmission setting.

In step S812, the printer 103 stops transmitting all of the printer information including status information (e.g., information about the number of printed sheets and a remaining ink amount) and printing information to be used for executing printing to the printer management server 101.

According to the present exemplary embodiment, the printer 103 can display a warning indicating necessity of an agreement on use of the personal Web service when registration of the personal Web service is newly executed in a state where the printer 103 has already been registered for the corporate Web service.

According to the present disclosure, it is possible to flexibly control transmission of device information with consideration for the user's agreement status based on a purpose of use of the image processing apparatus.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™, a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-044106, which was filed on Mar. 19, 2024 and which is hereby incorporated by reference herein in its entirety.

What is claimed is:

1. An image processing apparatus comprising:
one or more memories storing instructions; and
one or more processors capable of executing the instructions, wherein execution of the instructions causes the one or more processors to control the image processing apparatus to:
transmit a request including identification information of the image processing apparatus to a management server in order to use a first service, in a case where an input is received with respect to an arrangement on transmission of first information about use of the image processing apparatus which excludes personal information of a user of the image processing apparatus; and
provide, based on a notification from the management server, in order to use the first service, a screen for acquiring an arrangement on transmission of second information about use of the image processing apparatus which includes the personal information.

2. The image processing apparatus according to claim 1,
wherein the second information is not transmitted to an outside of the image processing apparatus via a network unless an input is received with respect to the arrangement on transmission of second information via the screen provided, and
wherein, in a case where an input is received with respect to the arrangement on transmission of second information via the screen provided, the second information is transmitted to the outside of the image processing apparatus via the network.

3. The image processing apparatus according to claim 1, wherein, in a case where an input is received with respect to the arrangement on transmission of second information via the screen provided, a transmission setting for transmitting the second information is enabled by the image processing apparatus.

4. The image processing apparatus according to claim 1, wherein, in a case where a notification indicating addition of a second service which requires transmission of the second information about use of the image processing apparatus including the personal information is received from the management server and the arrangement on transmission of the second information has not yet been acquired, the screen for acquiring the arrangement on transmission of the second information is provided.

5. The image processing apparatus according to claim 1, wherein information about a recording material is included in the first information and the second information.

6. A method executed by an image processing apparatus comprising:
transmitting a request including identification information of the image processing apparatus to a management server in order to use a first service, in a case where an input is received with respect to an arrangement on transmission of first information about use of the image processing apparatus which excludes personal information of a user of the image processing apparatus; and
providing, based on a notification from the management server, in order to use the first service, a screen for further acquiring an arrangement on transmission of second information about use of the image processing apparatus which includes the personal information.
